(19) United States
(12) Patent Application Publication
(10) Pub. No.: US 2014/0020851 A1
(43) Pub. Date: Jan. 23, 2014

(54) INSULATED GLASS BLIND ASSEMBLY

(71) Applicants: Allen Christopher Ouzts, Holland, MI (US); Benjamin Patrick Hummel, Rockford, MI (US); Michael Shane Eveland, Fennville, MI (US); Marc Richard Spetoskey, Allendale, MI (US)

(72) Inventors: Allen Christopher Ouzts, Holland, MI (US); Benjamin Patrick Hummel, Rockford, MI (US); Michael Shane Eveland, Fennville, MI (US); Marc Richard Spetoskey, Allendale, MI (US)

(73) Assignee: ODL, INCORPORATED, Zeeland, MI (US)

(21) Appl. No.: 13/996,803

(22) PCT Filed: Dec. 21, 2011
(86) PCT No.: PCT/US11/66407

§ 371 Date: Sep. 18, 2013

Related U.S. Application Data
(60) Provisional application No. 61/426,054, filed on Dec. 22, 2010.

(51) Int. Cl. E06B 9/264

(52) U.S. Cl. CPC E06B 9/264
USPC 160/107; 160/127

(57) ABSTRACT

An insulated glass assembly providing a simple and effective construction for installing a modular assembly inside the insulated glass assembly. The insulated glass assembly may include a spacer frame configured to support the modular assembly, such as a modular blind or shade assembly. The modular assembly may include a head rail module and a control operator module that may be captured by the spacer frame. For example, the spacer frame may capture the head rail module near the upper portion or the lower portion of the insulated glass blind assembly, and may capture the control operator module on a side adjacent to the head rail module.

### FIELD OF THE INVENTION

The present construction relates to insulated glass assemblies having internal blinds and shades, and more particularly to actuators for such internal blinds and shades.

### BACKGROUND OF THE INVENTION

Insulated glass (IG) assemblies having internal blinds or shades are used in various environments because, unlike external blinds, internal blinds or shades typically do not collect dirt and are protected from impacts that may otherwise bend or damage an external blind.

Around the perimeter of glass panes used to form the IG assembly is a spacer frame used in conjunction with a sealant to secure and separate the glass panes. Internal blinds are enclosed within the IG assembly, which includes a head rail assembly, a plurality of slats suspended from the head rail assembly, and cords connected to the head rail assembly for raising, lowering, or tilting the slats. The internal blinds further include operators for raising/lowering the slats and operators for tilting the slats. Operators slide on the exterior surface of the glass and magnetically couple to a follower within the insulated glass assembly.

In recent years, warm edge spacer frames have been used to increase energy efficiency. One example of a warm edge spacer frame is the Intercept® spacer frame from PPG Industries, Inc. The warm edge design of the Intercept® spacer frame includes a one-piece spacer frame having a U-shaped construction. When temperature changes cause the IG assembly to expand and contract, the warm edge spacer frame may flex instead of the sealant—preventing sealant fatigue and failure. The warm edge configuration also may lack seams at the corners of the IG assembly preventing leaks near the corners, which can be present in other spacer configurations. Further, because the glass contacts the sealant in this configuration rather than the spacer frame, the thermal conductivity at the perimeter of the IG assembly is relatively low—preventing energy loss.

While the warm edge spacer frame construction provides certain advantages, a simple and reliable construction for suspending an internal blind or shade from the spacer frame has yet to be developed. One conventional solution is to use discrete head rail clips that (1) clip into a U-channel of the spacer frame and (2) clip into the head rail assembly. The discrete head rail clips leave gaps between the head rail assembly and the spacer frame. Additionally, if one of the discrete head rail clips fails, then the head rail may fall within the IG assembly causing the internal blind to become inoperable.

### SUMMARY OF THE INVENTION

An insulated glass assembly providing a simple and effective construction for installing a modular assembly inside the insulated glass assembly. The insulated glass assembly may include a spacer frame configured to support the modular assembly, such as a modular blind or shade assembly. The modular assembly may include a head rail module and a control operator module that may be captured by the spacer frame. For example, the spacer frame may receive at least a portion of the head rail module near the upper portion or the lower portion of the insulated glass assembly, and may receive at least a portion of the control operator module on a side adjacent to the head rail module. Glass, as used herein, is defined as any transparent or translucent material. For instance, glass may be silica glass, polymer glass (e.g., Plexiglas), or non-silica glass.

In one embodiment, the spacer frame may be defined by a generally U-shape having an outer surface and edge portions. The outer surface may separate a pair of glass panels, and the edge portions may couple to the glass panels such that a glass panel is attached to each side of the spacer. In some embodiments, a sealant is used to couple the glass panels to the edge portions. The U-shaped construction of the spacer may be capable of capturing modular components, such as the head rail module and the control operator module, that form the modular assembly inside the insulated glass.

In another embodiment, the control operator module may be connected to the head rail module during assembly. A keyed tilt shaft in the head rail module may fit into a keyed pulley located in the control operator module. The control operator module may be installed or snapped in the spacer frame before, after, or at the same time as the head rail module during assembly. Additionally, the control cords for a slat assembly may be situated in the head rail module and the control operator module so that the cords retain freedom of movement when the modules are installed in the insulated glass.

In yet another embodiment, the U-shaped spacer includes a lip that engages a depression in the head rail module that extends along a portion of the length of the head rail module. In some embodiments, the depression may extend along the entire length of the head rail module. By engaging the lip of the U-shaped channel, the depression may enable the U-shaped spacer to capture and support the weight of the modular assembly inside the insulated glass.

In a further embodiment, the U-shaped spacer may include a protrusion or projection that engages a depression in the head rail module. With this configuration, the U-shaped spacer may engage the depression in the head rail module such that the U-shaped spacer captures and supports portions of the modular blind assembly inside the insulated glass.

In another aspect, the insulated glass assembly may include a control operator module for controlling operation of the modular assembly. The control operator module may be inside the insulated glass. Further, the control operator module may raise and lower the slats in the modular blind assembly, and may tilt the slats in the modular blind assembly. The control operator module may be located at one side of the insulated glass adjacent to the head rail module, and may be captured by the U-shaped spacer. An external operator, outside of the insulated glass, may operate the control operator module using magnetic coupling.

In other embodiments, the control operator module may include a tilt pulley for controlling operation of a tilt barrel assembly located within the head rail module. The shaft of the tilt barrel assembly may be keyed to fit the tilt pulley located within the control operator module. Accordingly, the control operator module may rotate the tilt pulley using a tilt cord, causing rotation of the tilt barrel assembly and tilting of the slats in the modular blind assembly.

These and other advantages and features of the insulated glass assembly will be more fully understood and appreciated by reference to the description of the embodiments and the drawings.

Before the embodiments of the insulated glass assembly are described, it is pointed out that the insulated glass assembly is not limited in its application to the details of construction and the arrangement of the components set forth in the following description or illustrated in the drawings. The insulated glass assembly is capable of other embodiments and of being practiced or being carried out in various ways. Also, it is pointed out that the phraseology and terminology used herein are for the purpose of description and should not be regarded as limiting. The use of “including” and “comprising” and variations thereof is meant to encompass the items listed thereafter and equivalents thereof, as well as additional items and equivalents thereof.

### BRIEF DESCRIPTION OF THE DRAWINGS

FIG. 1 is an exploded perspective view of the insulated glass assembly.

FIG. 2 is a fragmentary exploded perspective view of the insulated glass assembly.

FIG. 3A is a front view of the insulated glass assembly.

FIG. 3B is a side view of the insulated glass assembly.

FIG. 4 is a cross-sectional view of the front of the insulated glass assembly.

FIG. 5 is a fragmentary cross-sectional view of the front of the insulated glass assembly.

FIG. 6 is a cross-sectional view of the top of the insulated glass assembly.

FIG. 7 is a fragmentary cross-sectional view of the top of the insulated glass assembly.

FIG. 8 is a fragmentary cross-sectional view of the top of the insulated glass assembly.

FIG. 9 is a cross-sectional view of the right side of the insulated glass assembly.

FIG. 10 is a fragmentary cross-sectional view of the right side of the insulated glass assembly.

### DESCRIPTION OF THE CURRENT EMBODIMENTS

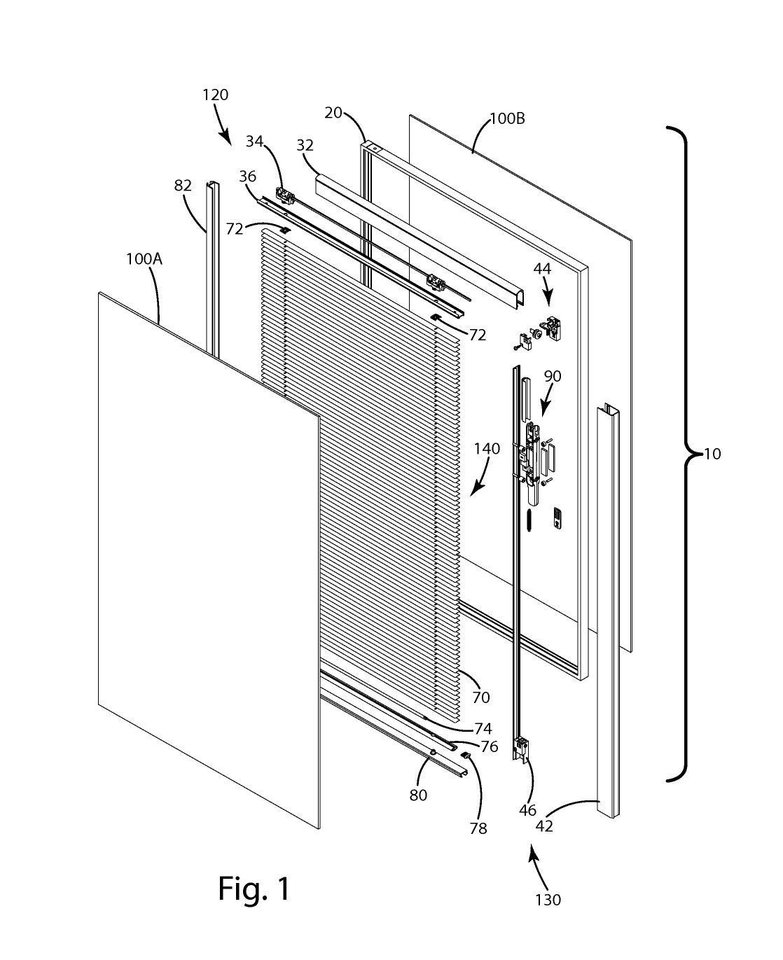

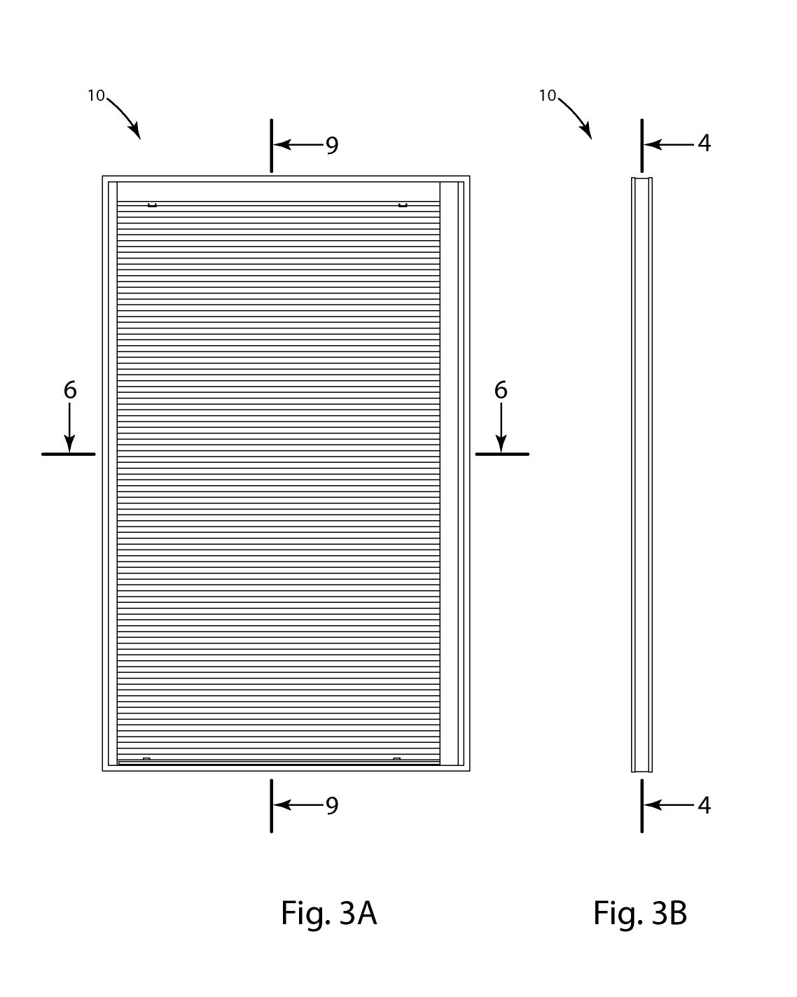

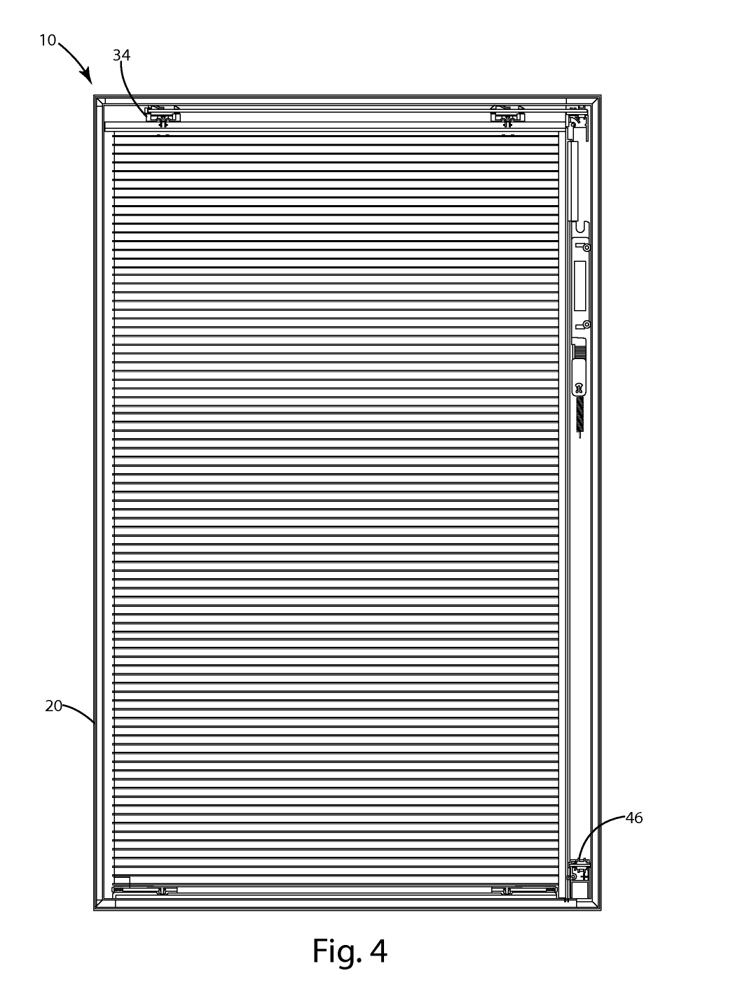

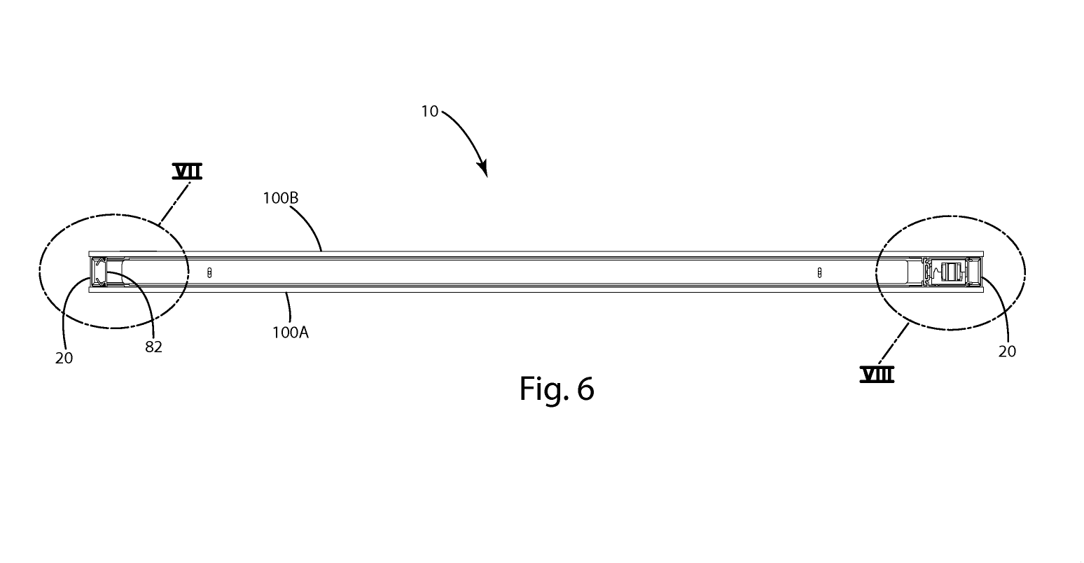

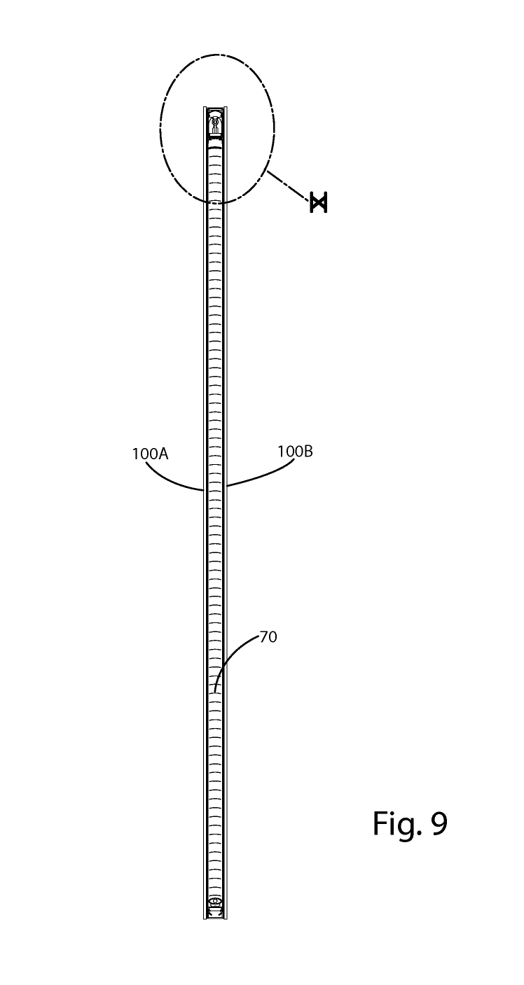

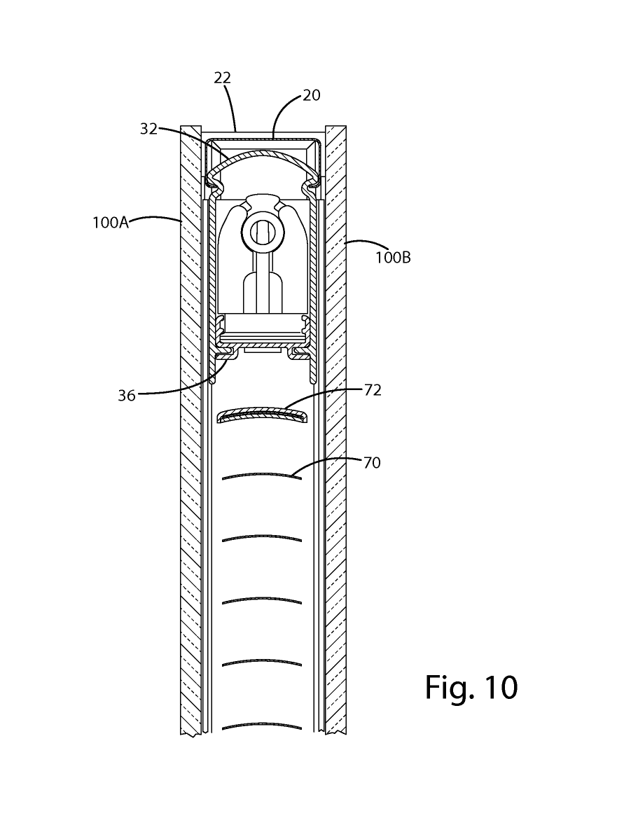

An illustration of the current embodiment of an insulated glass (IG) assembly is shown in FIGS. 1-10 and generally designated 10. The insulated glass window/blind assembly 10 may include a spacer frame 20, a pair of glass panes 100A and 100B, and a modular blind assembly. The glass panes 100A and 100B may be coupled to the spacer frame 20 via a sealant, and the modular blind assembly is within the IG blind assembly 10.

The modular blind assembly, as illustrated, includes a head rail module 120, a control operator module 130, and a slat assembly 140. For purposes of disclosure, the modular blind assembly is described in connection with a slat assembly 140, but alternative constructions may use a shade or other window covering or other window accessory instead of a slat assembly. The head rail module 120 and slat assembly 140 are suspended from the spacer frame 20 and raised/lowered or tilted by the control operator 90. The control operator 90 magnetically couples to an operator device located outside the IG blind assembly 10.

The spacer frame 20 is generally well known in the art and used in a variety of applications. Typically, the spacer frame 20 is either tin or stainless steel and extends around the perimeter of an insulated glass assembly, defining a space between glass panes. Glass panes are adhered to the spacer frame 20 using sealant 22 and seated to the spacer frame 20 to secure the assembly together. For the insulated glass assembly 10, the spacer frame 20 defines a space between glass panes 100A and 100B, where the modular blind assembly both occupies the space and suspends from the spacer frame 20. A desiccant is included within the space to absorb moisture within the insulated glass assembly 10. Alternative embodiments may include an inert gas, which occupies the space to decrease the thermal conductivity of the insulated glass assembly 10.

The spacer frame 20 of the current embodiment is a one-piece frame with a U-shaped construction. In use, the spacer frame 20 may flex when the space between the glass panes 100A and 100B expands and contracts due to temperature fluctuations. The one-piece construction of the spacer frame 20 further prevents leaks from forming in the insulated glass assembly 10 because unlike multi-piece spacer frames, the one-piece construction may lack seams near the corners. The cross sectional view shown in FIG. 10 shows a typical construction for spacer frame 20. The spacer frame 20 is defined by an outer surface, which separates the glass panes 100A and 100B, and edge portions. The sealant 22 connects the edge portions of the spacer frame 20 to the glass panes 100A and 100B. Each edge portion includes a lip near the end that curves away from the respective, adjacent glass pane 100A and 100B. In alternative embodiments, each edge portion may include a protrusion or other type of projection that extends away from the respective, adjacent glass pane 100A and 100B.

In alternative embodiments, the spacer frame 20 may not include a U-shaped construction, but may include another construction suitable for use with a modular blind assembly. For example, the spacer frame 20 may include another type of attachment configuration between the head rail module 120 and the spacer frame 20 for suspending the modular blind assembly from the spacer frame inside the insulated glass assembly 10.

In the current embodiment, the modular blind assembly includes a control operator module 130, a head rail module 120, and a slat assembly 140, where the head rail module 120 supports and controls the slat assembly 140.

The head rail module 120 may include a head fascia 32, a tilt barrel assembly 34, and a head plate 36. Ridges within the head fascia 32 may support the head plate 36. And the head plate 36 may support the tilt barrel assembly 34 inside the head fascia 32. The tilt barrel assembly 34, in conjunction with cords, may be configured to control tilting of the slat assembly 140. The tilt barrel assembly 34 also may provide support for additional cords used, for example, to raise and lower the slat assembly 140. Further, the tilt barrel assembly 34 in the current embodiment includes a keyed shaft that interfaces with a tilt pulley 44 in the control operator module 130.

The head fascia 32 may cover a portion of the tilt barrel assembly 34 and the head plate 36 such that the tilt barrel assembly 34 and head plate 36 are obscured or removed from view from the front or back of the insulated glass assembly 10. The head fascia 32 also may include a depression that extends across a portion of the length of the head fascia 32. In the current embodiment, the depression extends across the entire length of the head fascia 32. The depression may be inward and located on both the front and back of the head fascia 32. Alternative embodiments may include an outward protrusion rather than a depression. Other alternative embodiments may include more than one depression or protrusion across a portion of the length of the head fascia 32. Yet further alternative embodiments of the head fascia 32 may include both protrusions and depressions.

In the current embodiment, the upper portion of the spacer frame 20 captures the head rail module 120. In alternative embodiments, the head rail module 120 may be captured by the lower portion or bottom of the spacer frame 20 for a bottom-up design modular blind assembly. In other alternative embodiments, the head rail module 120 may be installed on a side of the insulated glass assembly 10 adjacent the upper or lower portion of the spacer frame 20.

As perhaps best illustrated in FIG. 10, the edge portions of the spacer frame 20 capture the depressions in the head fascia 32. A lip near the end of the edge portions may fit within the depression in the head fascia 32 in order to suspend the head rail module 120 from the spacer frame 20. More specifically, the entire length of the head fascia 32 may be captured by the lip of the spacer frame 20, which engages the depression of the head fascia 32. Alternative embodiments may include a spacer frame 20 with protrusions or projections capable of capturing the head rail module 120, and further alternatives may include a spacer frame 20 having both protrusions and depressions.

The slat assembly 140 of the current embodiment includes a plurality of individual slats 70, a string ladder (not shown), control cords (not shown), tilt cords (not shown), and a weighted bottom rail 76. The individual slats 70 are suspended from the head rail module 120 on the string ladder. The individual slats 70 are adjusted by changing the position of the control operator 90, which moves the control cords. For example, raising and lowering the individual slats 70 may be accomplished by raising and lowering the weighted bottom rail 76, which is attached to the control cords. The control cords pass through the apertures in the individual slats 70, through the slat clip 72, and through the head rail assembly to the control operator 90 in the control operator module 130. The tilt cords also may be controlled by the control operator module 130, and attach to the tilt barrel assembly 34. The weighted bottom rail 76 may include weights 74 and end caps 78.

The control operator module 130 may include a tilt pulley 44, a control operator 90, a bottom pulley 46, and an operator fascia 42. The control operator module 130 may be installed in the blind assembly 10 along either side of the insulated glass assembly 10 such that it is adjacent to the head rail module 120. Alternatively, the control operator module 130 may be installed on the top or bottom of the insulated glass assembly 10. As an example, in alternative embodiments having the head rail module 120 installed along on a side of the insulated glass assembly 10 that is adjacent the top or bottom, the control operator module 130 may be installed on the bottom of the insulated glass assembly 10.

The control operator module 130 may be capable of controlling both tilt and raising/lowering of the slat assembly 140. A control cord (not shown) and a tilt cord (not shown) are connected to the control operator 90, where the tilt cord travels over the tilt pulley 44 and the bottom pulley 46, and where the control cord may be connected to both the control operator 90 and the weighted bottom rail 76. In the current embodiment, the control operator 90 may travel along the length of the operator fascia 42. At one range of positions along the operator fascia 42, such as near an end, movement of the control operator 90 may affect the tilt of the individual slats 70, and at another range of positions, movement of the control operator 90 may raise or lower the individual slats 70. In alternative embodiments, the relationship between the position of the control operator 90 and the tilt and level of the individual slats 70 may be different.

For purposes of disclosure, the insulated glass assembly 10 is described in connection with a single control operator 90, but it is to be appreciated that two or more control operators may be used to control the window covering or window accessory within the insulated glass assembly 90. For example, one control operator may raise and lower the window covering or window accessory, and another control operator may control the amount of light capable of passing through the window covering or window accessory (for example, by controlling the tilt of slats). The control operator module 130 may include all of the two or more control operators. However, in further alternative embodiments, one or more control operators may be included in the control operator module 130 while other one or more control operators may be included in at least one of (a) the head rail module 120 and (b) another control operator module positioned on an opposite side or adjacent side of the insulated glass assembly 10 with respect to the position of the control operator module 130.

In the current embodiment, the tilt pulley 44 is keyed to fit with the shaft of the tilt barrel assembly 34. Movement of the control operator 90 and the tilt cord may cause the tilt pulley 44 to rotate the tilt barrel assembly 34, which in turn causes the individual slats 70 to tilt. The tilt cord also may travel along the bottom pulley 46 and connects to the tension spring 48, which is connected to the control operator 90.

The operator fascia 42 may be constructed similarly to the head fascia 32, and may include depressions along a portion of its length that may be captured by the spacer frame 20. Further, an operator plate 54 may fit within ridges in the operator fascia 42 along the side of the operator fascia opposite to the spacer frame 20 in order to enclose the components within, such as the control operator 90, the tilt pulley 44, and the bottom pulley 46.

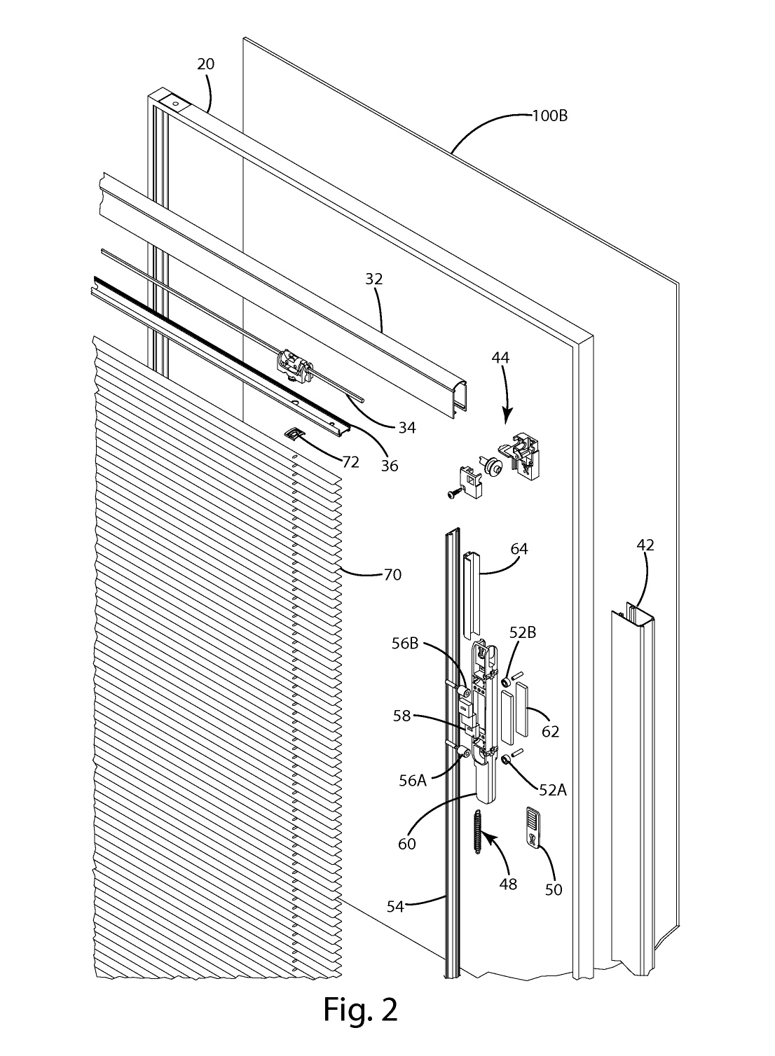

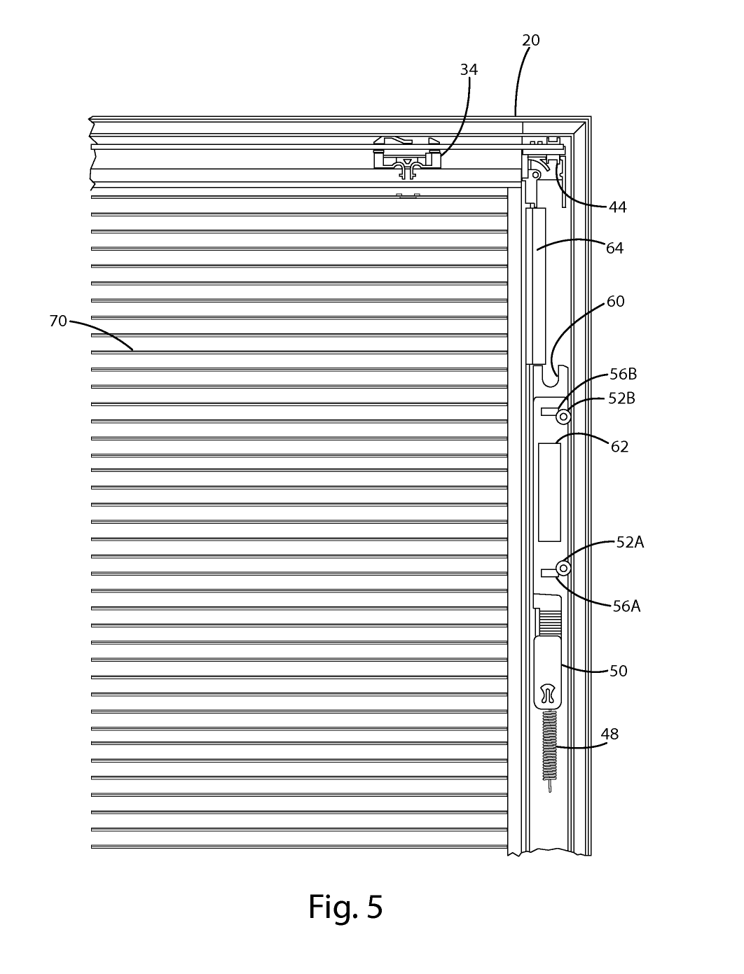

The control operator 90 may include multiple components, such as bearings 52A-B, 56A-B, spring adjustor 50, magnet plates 62, magnets 58, and the base operator structure 60. The base operator structure 60 may be formed of plastic, but other suitable materials may be used. The bearings 52A-B, 56A-B may help to maintain the position of the control operator 90 inside the operator fascia 42 and to prevent wear on the operator fascia 42 from movement of the control operator 90. The bearings 52A-B may be replaced with rollers in alternative embodiments. The spring adjustor 50 connects to the counterweight spring 48 and is adjustable to select the proper spring tension for operation. In the current embodiment, the magnets 58 are placed within a channel of the base operator structure 60. An external operator may be used to magnetically couple with the magnets 58 to move the control operator 90 to various positions within the insulated glass assembly 10. The type, shape, number, and location of the magnets 58 may vary from application to application. The magnet plates 62 may be used to hold the magnets 58 in place during use. A mechanical stop 64, shown in FIGS. 2 and 5, may also be included in the control operator module 130 to limit travel of the control operator 90. Alternative embodiments may include a mechanical stop 64 of a different construction, such as a screw, rivet, or other solid feature suitable to limit travel of the control operator 90.

The non-operator side fascia 82 and bottom fascia 80 may include a similar construction to the head fascia 42 such that they include a depression along a portion of their length. The non-operator side fascia 82 may be captured by the spacer frame 20 along a side adjacent to the head rail module 120 and opposite to the control operator module 130. Likewise, the bottom fascia 80 may be captured by the spacer frame 20 along a side opposite the head rail module 120. Similar to the head rail module 120 and control operator module 130, the non-operator side fascia 82 and bottom fascia 80 may be installed on any side, including the top or bottom, of the insulated glass assembly 10 in alternative embodiments.

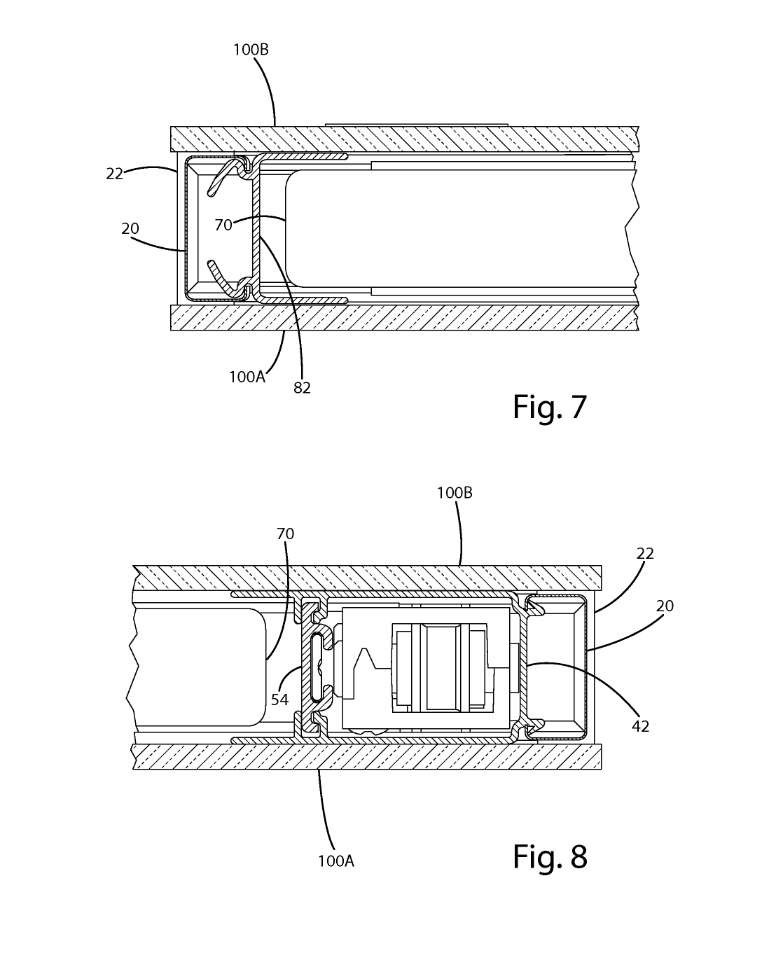

In the illustrated embodiment of FIGS. 7 and 8, the individual slats 70 of the slat assembly 140 may fit into a privacy channel of the operator fascia 42 and the non-operator side fascia 82 such that the ends of individual slats 70 are within at least 0.5 mm to 3 mm, about 2 mm, of the operator fascia 42 and the non-operator fascia 82. With this configuration, a perimeter portion of the slat assembly 140 may overlap with sides of the operator fascia 42 and the non-operator side fascia 82, thereby preventing or blocking light from passing through the insulated glass assembly 10 at either side of the slat assembly 140 when the slats 70 are tilted in a closed position. Put differently, the overlap between the perimeter portion of the slat assembly 140 and the fascias 42, 82 may prevent visibility or create privacy near the sides of the slat assembly 140 when the slats 70 are tilted in a closed position. In an alternative embodiment, a channel of the head fascia 32 and the bottom fascia 80 may be capable of overlapping the slat assembly 140, creating an element of privacy near the top and bottom of the insulated glass assembly 10 when the slat assembly 140 is in a closed position.

For purposes of disclosure, the privacy channel configuration is described in connection with the slat assembly 140 and the individual slates 70. However, other embodiments may include a different window covering or window accessory instead of the slat assembly 140. Similar to the illustrated embodiment, the different window covering or window accessory may be have its sides fitted into the privacy channel of the operator and non-operator fascias 42, 82, thereby preventing visibility or creating privacy near the sides of the window covering or window accessory. In alternative embodiments, the different window covering or window accessory may be capable of fitting within a channel of the head fascia 32 and bottom fascia 80 as described above.

A desiccant may be contained in the spacer frame 20 in order to prevent moisture condensation inside the insulated glass assembly 10. For example, the desiccant may be applied around the periphery of the U-shaped spacer frame 20. The desiccant may be a matrix type desiccant or another suitable desiccant capable of absorbing moisture inside the insulated glass assembly 10.

In the illustrated embodiment of FIGS. 1-10, the profile of the head rail module 120, control operator module 130, non-operator fascia 82, and bottom fascia 80 may be configured such that these components snap-in the spacer frame 20. It is to be appreciated the profile may be fine-tuned for snapping-in the spacer frame 20. In other words, the production profile of the components adapted to snap-in the spacer frame 20 may be slightly different from that shown in the illustrated embodiment. For example, the radius and shape of the depression, as shown in the illustrated embodiment of FIG. 10, adapted to snap-in the spacer frame 20 may be different in alternative embodiments.

### II. Assembly

The spacer frame 20 is assembled from a single piece of metal of a U-shaped construction as is well known in the art, and may be unmodified from its off the shelf form for assembly in the insulated glass assembly 10. Those skilled in the art will recognize that a modified spacer frame 20 or a multi-piece spacer frame 20 having a U-shaped construction may be used in alternative embodiments. Returning to the current embodiment, a sealant 22 then is attached to the spacer frame 20. Before installing the head rail module 120, the tilt barrel assembly 34 and head plate are installed in the head fascia 32 along with the tilt cords and control cords, which are attached to the slat assembly 140. The control cords also may be connected to the control operator module 130 before installing the head rail module 120. The control operator module 130 and the head rail module 120 may be or may not be connected together before installation such that the keyed tilt shaft is inserted into the keyed pulley 44. The head rail module 120 may be installed before, after, or at the same as the head rail module 120. Either module may be installed by pushing the module into the spacer frame 20 until the depression engages the lip of the spacer frame 20 such that the module is captured and secured in place. The non-operator side fascia 82 and bottom fascia 80 also may be pushed into the spacer frame 20 until they snap into place or become captured.

Alternatively, the control operator module 130 may be installed in the spacer frame 20, before the head rail module 120, by pushing the control operator module 130 into one of the sides of the spacer frame 20 until it snaps into place or becomes captured. The head rail module 120 then may be installed by inserting the keyed tilt shaft of the tilt barrel assembly 34 into the keyed pulley 44, and pushing the head rail module 120 into the upper portion of the spacer frame 20 until it snaps into place or becomes captured. The non-operator side fascia 82 and bottom fascia 80 also may be pushed into the spacer frame 20 until they snap into place or become captured.

The above description is that of the current embodiments of the insulated glass blind assembly. Various alterations and changes can be made without departing from the spirit and broader aspects of the insulated glass blind assembly. It is pointed out that the insulated glass blind assemblies disclosed herein extend to all alternative combinations of two or more of the individual features mentioned or evident from the text and/or drawings. All of these different combinations constitute various alternative aspects of the insulated glass blind assembly.

1. A window assembly comprising:
a glass assembly including at least two glass panels and a spacer between the glass panels, the spacer being disposed near a perimeter of the glass assembly; and
a modular assembly within the glass assembly, the modular assembly comprising:
a head rail module adapted to support a window accessory, the head rail module at least partially captured within or by the spacer of the glass assembly along a first portion of the perimeter of the glass assembly such that the head rail module is fixed to the spacer, wherein the head rail module is adapted for modular installation along the first portion of the perimeter portion of the glass assembly; and
a control operator module adapted to control operation of the window accessory, the control operator module being separable from the head rail module, the control operator module at least partially captured within the spacer of the glass assembly along a second portion of the perimeter of the glass assembly different from the first portion such that the control operator module is fixed to the spacer, wherein the control operator module is adapted for modular installation along the second portion of the perimeter of the glass assembly.

2. The window assembly of claim 1 wherein the control operator module is contained within the glass assembly and is adapted to raise and lower the window accessory.

3. The window assembly of claim 1 wherein the control operator module is contained within the glass assembly and is adapted to tilt one or more slats of the window accessory.

4. The window assembly of claim 1 wherein:
the head rail module includes a keyed shaft received by the control operator module; and
the control operator module is adapted to rotate the keyed shaft.

5. The window assembly of claim 1 wherein the control operator module includes a magnetic follower adapted to magnetically couple with an external operator outside the glass assembly.

6. The window assembly of claim 1 wherein the window accessory is one of a blind or shade.

7. The window assembly of claim 1 wherein the glass assembly includes an upper side, a lower side, and two sides therebetween,
wherein the first portion of the perimeter portion along which the head rail module is modularly installed is either the upper side or the lower side of the glass assembly,
and wherein the second portion of the perimeter portion along which the control operator module is modularly installed is one of the two sides between the upper and lower sides.

8. The window assembly of claim 1 wherein the spacer is generally U-shaped such that the spacer defines an outer surface having an edge portion on either side of the outer surface, wherein the outer surface spaces apart and separates the glass panels, and wherein each edge portion couples to one of the glass panels.

9. The window assembly of claim 8 wherein each edge portion includes a lip near an end of each edge portion, the end being distally located from the outer surface, and wherein the lip extends along a length of the spacer.

10. The window assembly of claim 9 wherein the lip engages a depression of the head rail module so that the spacer captures the head rail module, and wherein the lip engages a depression of the control operator module so that the spacer captures the control operator module.

11. The window assembly of claim 8 wherein each edge portion includes a protrusion distal from the outer surface.

12. The window assembly of claim 8 wherein each edge portion includes at least one protrusion and at least one depression, wherein the at least one protrusion and the at least one depression are distal from the outer surface and are adapted to engage the head rail module so that the spacer captures the head rail module.

13. The window assembly of claim 1 further comprising a sealant that couples the spacer to the glass panels.

14. The window assembly of claim 1 further comprising a fascia captured by the spacer and located along a side of the glass assembly opposite to the head rail module or the control operator module.

15. The window assembly of claim 1 wherein the spacer is a one-piece spacer frame disposed about a perimeter of the glass assembly.

16. An insulated glass assembly comprising:
a pair of glass panels;
a spacer including an outer surface and edge portions on either side of the outer surface, the spacer coupled to each of the glass panels and separating the glass panels, wherein the spacer and glass panels define a space between the pair of glass panels;
a head rail module within the space defined by the spacer and the glass panels, the head rail module adapted to support a window accessory within the space, the head rail module fitted between the edge portions of the spacer such that the spacer fixedly receives the head rail module therein, wherein the head rail module is adapted for modular installation near a first perimeter portion of the insulated glass assembly; and
a control operator module contained within the space defined by the spacer and glass panels, the control operator module adapted to control operation of the window accessory and being separable from the head rail module;
wherein the control operator module fits between the edge portions of the spacer such that the spacer fixedly receives the control operator module therein, wherein the control operator module is adapted for modular installation near a second perimeter portion of the insulated glass assembly, the first perimeter portion of the insulated glass assembly being different from the second perimeter portion of the insulated glass assembly.

17. The insulated glass assembly of claim 16 wherein the head rail module includes a keyed shaft that engages a keyed pulley of the control operator module, wherein the control operator module is capable of rotating the keyed pulley and the keyed shaft in order to tilt one or more slats of the window accessory.

18. The insulated glass assembly of claim 16 wherein the control operator module is adapted to raise and lower the window accessory.

19. The insulated glass assembly of claim 16 wherein the spacer is a generally U-shaped one-piece spacer, wherein the spacer is unmodified, and wherein the head rail module is adapted to snap-in the spacer.

20. The insulated glass assembly of claim 16 wherein the window accessory is one of a blind or a shade.

21. A window assembly comprising:
a glass assembly including at least two glass panels and a spacer between the glass panels; and
a modular assembly within the glass assembly, the modular assembly comprising:
a head rail module adapted to support a window covering, the head rail module mounted at least partially within the spacer of the glass assembly, wherein the head rail module is adapted for modular installation at least partially within the spacer; and
a control operator module adapted to control operation of the window covering, the control operator module mounted at least partially within the spacer of the glass assembly, wherein the control operator module is adapted for modular installation at least partially within the spacer such that the spacer is fixed to the control operator module, wherein the head rail module and control operator module are adapted to be installed separately.

22. The window assembly of claim 21 wherein the control operator module is contained within the glass assembly and is adapted to control operation of the window covering.

23. The window assembly of claim 21 wherein the head rail module includes a keyed shaft received by the control operator module, and wherein the control operator module is adapted to rotate the keyed shaft.

24. The window assembly of claim 21 wherein the spacer includes an outer surface and edge portions on either side of the outer surface, wherein the head rail is fitted between the edge portions of the spacer such that the head rail is at least partially within the spacer.

25. The window assembly of claim 24 wherein each edge portion includes a lip near an end of each edge portion, the end being distally located from the outer surface, and wherein the lip extends along a length of the spacer and engages a depression of the head rail module so that the spacer captures the head rail module.

26. The window assembly of claim 21 wherein the glass assembly includes an upper side, a lower side, and two sides therebetween, wherein the head rail module is located on either the upper side or the lower side of the glass assembly.

27. The window assembly of claim 21 wherein the spacer is a one-piece spacer frame disposed about a perimeter of the glass assembly.

28. A window assembly comprising:
a glass assembly including at least two glass panels and a spacer between the glass panels; and
a side fascia within the glass assembly and coupled to the spacer along a side of the glass assembly, the side fascia having a privacy channel;
a window accessory within the glass assembly, a perimeter portion of the window accessory being within the privacy channel such that the privacy channel overlaps the perimeter portion of the window accessory, the privacy channel being adapted to substantially block light from passing through the glass assembly near the perimeter portion of the window accessory; and
a modular assembly within the glass assembly comprising:
a head rail module adapted to support the window accessory, the head rail module coupled to the spacer of the glass assembly along a first portion of the perimeter of the glass assembly; and
a control operator module adapted to control operation of the window accessory, the control operator module coupled to the spacer of the glass assembly along a second portion of the perimeter of the glass assembly different from the first portion, wherein the head rail module and control operator module are each adapted for separate and modular coupling to the spacer of the glass assembly.

29. The window assembly of claim 28 wherein the side fascia is coupled to the spacer along at least one of the upper side, lower side, a first side between the upper and lower sides, and a second side between the upper and lower sides.

30. The window assembly of claim 28 wherein the side fascia forms part of the control operator module.

31. The window assembly of claim 28 wherein the side fascia forms a non-control operator fascia opposite to the control operator module and coupled to the spacer of the glass assembly.

32. The window assembly of claim 28 wherein the side fascia forms part of the head rail module.

33. The window assembly of claim 28 wherein the window accessory is a blind or a shade.
